(19) United States
(12) Patent Application Publication
(10) Pub. No.: US 2013/0300696 A1
(43) Pub. Date: Nov. 14, 2013

(54) METHOD FOR IDENTIFYING PALM INPUT TO A DIGITIZER

(71) Applicant: N-trig Ltd., Kfar-Saba (IL)

(72) Inventors: On HARAN, Kfar-Saba (IL); Sharon PELEG, Hod-HaSharon (IL); Amir ZYSKIND, Natania (IL); Arthur GERSHFELD, Akko (IL); Eyal BOUMGARTEN, Kiryat-Ono (IL); Nadav LINENBERG, Even-Yehuda (IL)

(73) Assignee: N-trig Ltd., Kfar-Saba (IL)

(21) Appl. No.: 13/892,381

(22) Filed: May 13, 2013

Related U.S. Application Data
(60) Provisional application No. 61/646,377, filed on May 14, 2012.

(51) Int. Cl. G06F 3/041

(52) U.S. Cl. CPC G06F 3/041
USPC 345/173

(57) ABSTRACT

A method for classifying input provided to a digitizer sensor includes sampling output over one or more sampling periods, identifying a location of intentional input to the digitizer sensor from the output sampled over the one or more sampling periods, identifying an area of potential palm input based on the identified location of the intentional input, and classifying output detected in the area of the potential palm input as output potentially obtained from undesired input to the digitizer sensor. The area of potential palm input is defined to have a defined spatial relation to the location of the intentional input. The output classified is sampled over one or more sampling periods other than the one or more sampling periods from which the area of potential palm input is identified.

### RELATED APPLICATION

This application claims the benefit of priority under 35 USC 119(e) of U.S. Provisional Patent Application No. 61/646,377 filed May 14, 2012, the contents of which are incorporated herein by reference in their entirety.

### FIELD OF THE INVENTION

The present invention relates to multi-touch digitizer systems, and more particularly to recognition of palm input to a multi-touch digitizer.

### BACKGROUND OF THE INVENTION

Touch technologies are commonly used as input devices for a variety of products. The usage of touch devices of various kinds is growing sharply due to the emergence of new mobile devices such as Personal Digital Assistants (PDA), tablet PCs and wireless Flat Panel Displays (FPDs). These new devices may not be connected to standard keyboards, mice or like input devices, which are deemed to limit their mobility. Instead there is a tendency to use touch sensitive digitizers of one kind or another. A stylus and/or fingertip may be used for user input. In some known capacitive based touch sensitive digitizers, input can be provided by both touching and hovering over the digitizer with the stylus and/or fingertip. One kind of touch sensitive digitizer is a touch screen.

One known difficulty in user input recognition with touch sensitive digitizers is that while a user provides input with a fingertip, additional portions of the user's hand, e.g. palm may also inadvertently touch the digitizer sensor and thus supply input. In addition, a user may inadvertently provide input with a thumb and/or palm while holding a stylus or resting a hand on the touch sensitive digitizer. Different methods for distinguishing between intended input and inadvertent input provided to a touch sensitive digitizer have been proposed.

U.S. Patent Application Publication No. 2009-0095540, entitled “Method for Palm Touch Identification in Multi-Touch Digitizing Systems,” assigned to N-Trig Ltd., the contents of which is incorporated herein by reference, describes a method for classifying input to a multi-touch sensitive digitizer that is obtained from a body part, as inputs invalid for user interaction and inputs valid for user interaction. The method includes identifying a plurality of discrete regions of input to a digitizer sensor, determining one or more spatial relations between at least two of the regions, and classifying one of the at least two regions as either valid input region or invalid input region, based on the spatial relation determined between the at least two regions. An invalid region can be input resulting from interaction by palm or another body part inadvertently touching the sensor, and valid input can be input resulting from a finger tip interaction.

U.S. Application Publication No. 2008-0012835, entitled “Hover and Touch Detection for a Digitizer,” assigned to N-Trig Ltd., the contents of which is incorporated herein by reference, describes a method for palm rejection for a digitizer sensor that includes detecting characteristics of hover event and a touch event related to the hover event. It is disclosed that spatial characteristics of an area over which the hover event is detected are analyzed together with characteristics of the touch event and the touch event is either verified or rejected as an intended user interaction based on the analysis.

U.S. Pat. No. 6,888,536 entitled “Method and apparatus for integrating manual input,” the contents of which is incorporated herein by reference, describes an apparatus and methods for simultaneously tracking multiple finger and palm contacts as hands approach, touch, and slide across a proximity-sensing, compliant, and flexible multi-touch surface. Segmentation processing of each proximity image constructs a group of electrodes corresponding to each distinguishable contact and extracts shape, position and surface proximity features for each group. Groups in successive images which correspond to the same hand contact are linked by a persistent path tracker which also detects individual contact touchdown and liftoff.

U.S. Pat. No. 6,459,424 entitled “Touch-sensitive input screen having regional sensitivity and resolution properties,” the contents of which is incorporated herein by reference, describes a touch screen panel having varied combinations of resolution and touch sensitivity. Optionally area of the screen typically used for highlighting and simple annotation is designed with low resolution and high touch force characteristics, thereby minimizing processor bandwidth and providing rejection of inadvertent touching such as palm touch. An alternate area of the screen used for digital signature input or for security marking input is designed with low touch force and high resolution properties. Optionally, the small area with the low touch force and high resolution properties may be placed in a corner of the screen where it is unlikely to be inadvertently touched. Either the varied screen properties may be incorporated into the screen during its manufacture or the screen may be designed so that the varied properties are programmable by the user. The varied screen properties are achieved with hardware.

U.S. Pat. No. 7,843,439, entitled “Touch Detection for a Digitizer,” assigned to N-Trig Ltd., the contents of which is incorporated herein by reference, describes a detector for detecting both a stylus and touches by fingers or like body parts on a digitizer sensor. The detector typically includes a digitizer sensor with a grid of sensing conductive lines, a source of oscillating electrical energy at a predetermined frequency, and detection circuitry for detecting a capacitive influence on the sensing conductive line when the oscillating electrical energy is applied, the capacitive influence being interpreted as a touch. The detector is capable of simultaneously detecting multiple finger touches and/or stylus touch.

U.S. Application Publication No. 2008-0012838 entitled “User Specific Recognition of Intended User Interaction with a Digitizer,” U.S. Application Publication No. 2006-0012580 entitled “Automatic Switching for a Dual Mode Digitizer,” and U.S. Pat. No. 8,059,102 entitled “Fingertip Touch Recognition for a Digitizer,” all assigned to N-Trig Ltd., the contents of all which are incorporated herein by reference, describe additional methods for palm rejection.

U.S. Application Publication No. 2011-0310040, entitled “System and Method for Finger Resolution in Touch Screens,” assigned to N-Trig Ltd., the contents of which is incorporated herein by reference, describes a method for detecting an area on a digitizer sensor that is touched with a plurality of fingers or other objects in close proximity to each other and identifying the location of each finger touch in the area detected. It is described that matrix defining ratios between voltage level measured in association with each junction of a digitizer sensor when the junction is touched and a voltage level measured in association with each corresponding junction when the junction is untouched is used to detect touch. It is further described that the location of each touch in the area detected is determined by applying a series of thresholds on the ratios defined over the touch area and comparing results obtained at the different threshold levels.

### SUMMARY OF THE INVENTION

An aspect of some embodiments of the present invention is the provision of a method for identifying input provided by a palm, hand, arm, fingers and/or other body parts not intentionally being used to provide input to a touch sensitive digitizer, and distinguishing such input from intentional fingertip inputs. Optionally, both intended and unintended input to a digitizer sensor may include one or more of input by touch and input by hovering. Typically, the unintended input is obtained from an object that is larger, e.g. substantially larger than an object used for intended input, e.g. finger tip or stylus tip input. According to some embodiments of the present invention, a potential area in which palm input is expected is defined in relation to an identified intentional input provided by a fingertip touch and/or a stylus. In some exemplary embodiments, input detected within potential area in which palm input is expected is invalidated as an intentional fingertip touch interaction. Optionally inadvertent and/or undesired input from a hand while accompanied with intentional input, e.g. from a fingertip and/or stylus, is detected and/or tracked and used to provide additional information that is used by the digitizer system and/or host to improve recognition and/or functionality.

As used herein, the terms ‘inadvertent input’ and ‘palm input’ refer to input provided by any one or more of a palm, hand, wrist, arm, knuckle, fist and thumb and/or folded fingers while not intentionally being used to provide input, such as may typically occur together with intended input provided with a fingertip and/or hand held object, e.g. a stylus. As used herein, the term ‘inadvertent input’ also includes other parts of the body that may typically come in contact with a touch screen. One example of such a body part is an ear or a cheek which may typically come into contact with a smart phone including a touch screen. Additionally, the terms ‘inadvertent input’ and ‘palm input’ also include the aforesaid input while not accompanied by an intended input.

According to an aspect of some embodiments of the present invention, there is provided a method for identifying inadvertent input provided to a digitizer sensor, the method comprising: sampling output over one or more sampling periods; identifying a location of intentional input to the digitizer sensor from the output sampled over the one or more sampling periods; identifying an area of potential palm input having a defined spatial relation to the location of the intentional input; and classifying output detected in the area of the potential palm input as output potentially provided inadvertently, wherein the output classified is sampled over one or more sampling periods other than the one or more sampling periods from which the area of potential palm input is identified.

Optionally, the area of potential palm input is updated over subsequent sampling periods and wherein the output is classified over the subsequent sampling periods.

Optionally, the area of potential palm input is defined as a dynamic area that is updated as the location of the intentional input is updated.

Optionally, the intentional input to the digitizer sensor is input provided by a stylus.

Optionally, the method comprises determining an orientation of the stylus and identifying the area of potential palm input in relation to the orientation of the stylus.

Optionally, determining an orientation of the stylus includes determining a three dimensional orientation of the stylus with respect to the digitizer sensor as identified.

Optionally, the area of potential palm input in relation to the orientation of the stylus is defined as an area on the digitizer sensor covered by the stylus and a hand holding the stylus.

Optionally, the method comprises determining a moving direction of the intentional input and defining the area of potential palm input in relation to the moving direction.

Optionally, the intentional input is input provided by one or more fingertip touches.

Optionally, the method comprises determining an angle of at least one fingertip touch with respect to an axis of the digitizer sensor; and defining the area of potential palm input in relation to the detected angle of at least one fingertip touch.

Optionally, the method comprises identifying one or more features of the at least one fingertip touch; identifying a hand structure from the one or more features; and determining the area of potential palm input responsive to the identified hand structure.

Optionally, the method comprises determining the output using more than sensing configuration; identifying an interaction area on the digitizer sensor that is larger than a threshold size area for identifying palm input; and defining the area of potential palm input in the vicinity of the interaction area that is larger than a threshold size area for identifying palm input.

Optionally, the method comprises sampling output using a self-capacitance detection method and a mutual capacitance detection method, and determining the area of potential palm input responsive to output obtained from both the self-capacitance detection method and the mutual capacitance detection method.

Optionally, the method comprises determining a size of an area over which the intentional input is provided over a plurality of sampling periods, and invalidating the input as intentional input responsive to the rate in the change of size being larger than a pre-defined rate.

Optionally, input detected within the area of potential palm input is refrained from being reported to the host.

Optionally, input detected within the area of potential palm input is reported to the host as inadvertent input.

Optionally, input detected within the area of potential palm input is associated with a reduced level of confidence that the input is an intentional input provided by fingertip touch.

Optionally, the intentional input to the digitizer sensor is one of touch input and hover input.

Optionally, a size of the area of potential palm input is a pre-defined.

Optionally, the pre-defined size is user specific.

According to an aspect of some embodiments of the present invention, there is provided a method for identifying inadvertent input provided to a digitizer sensor, the method comprising: sampling output over at least two sampling periods; determining an area of input based on the sampled output; determining a change in size of the area of input over the at least two sampling periods; and invalidating the input as intentional input responsive to the change of size being larger than a pre-defined threshold.

According to an aspect of some embodiments of the present invention, there is provided a method for detecting finger touch to a digitizer sensor, the method includes: defining a threshold level of output for identifying a presence of a finger over the digitizer sensor; determining a change in the digitizer sensor's impedance to ground; and adjusting the threshold level response to the change in the digitizer sensor's impedance to ground.

Optionally, the method includes defining ratios between voltage level measured in association with each junction of the digitizer sensor when the junction is touched and a voltage level measured in association with each corresponding junction when the junction is untouched is used to detect touch; and applying the threshold on the ratios to detect the presence of the finger over the digitizer sensor.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is an exemplary simplified block diagram of a digitizer system that can be used in some embodiments of the present invention;

FIG. 2 is a schematic illustration of an exemplary mutual capacitance detection method that can be used in some embodiments of the present invention;

FIGS. 3A and 3B are schematic illustrations of a self-capacitance detection method that can be used in some embodiments of the present invention;

FIG. 4 is a schematic illustration of a potential palm input area that is defined based on position of a stylus interacting with a digitizer sensor in accordance with some embodiments of the present;

FIG. 5 is a simplified flow chart of an exemplary method for identifying a potential palm input area during stylus interaction with a digitizer sensor in accordance with some embodiments of the present invention;

FIGS. 6A and 6B are exemplary schematic illustrations of hands interacting with a digitizer sensor and corresponding output detected on the digitizer sensor based on which a potential palm input area is defined in accordance with some embodiments of the present;

FIG. 7 is a simplified flow chart of an exemplary method for identifying a potential palm input area based on hand mapping during finger touch interaction with a digitizer sensor in accordance with some embodiments of the present invention;

FIGS. 8A, 8B and 8C are schematic illustrations of a finger interacting with a digitizer sensor and corresponding output obtained during mutual capacitance detection and self-capacitance detection respectively in accordance with some embodiments of the present;

FIG. 9 is a simplified flow chart of an exemplary method for identifying a potential palm input area using output obtained from self-capacitance detection method in accordance with some embodiments of the present invention;

FIG. 10 is a schematic illustration of a fingertip touch area and a palm touch area as detected over three consecutive sampling periods in accordance with some embodiments of the present invention;

FIG. 11 is a simplified flow chart of an exemplary method for identifying palm input and/or other inadvertent input based on changes in a touch area over a plurality of sampling periods in accordance with some embodiments of the present invention; and

FIG. 12 is a simplified flow chart of an exemplary method for adjusting a threshold level for detection based on variations in a system's impedance to ground in accordance with some embodiments of the present invention.

### DESCRIPTION OF SPECIFIC EMBODIMENTS OF THE INVENTION The present invention relates to multi-touch digitizer systems, and more particularly to recognition of palm input to a multi-touch digitizer.

According to an aspect of some embodiments of the present invention there is provided a method for identifying areas on a digitizer sensor over which palm input is expected. According to some embodiments of the present invention, areas on a digitizer sensor over which palm input is expected is defined in relation to an identified location of intentional input, e.g. stylus and/or fingertip touch. According to some embodiments of the present invention, the identified area over which palm input is expected is a dynamic area that moves as the location of intentional input is detected to move, and is optionally maintained as long as the identified intentional input is present, e.g. over a plurality of sampling periods.

According to some embodiments of the present invention, an assumption is made that intentional input within the defined area over which palm input is expected is unlikely. In some exemplary embodiments, input detected within that area is ignored, e.g. not reported, classified as palm input, and/or associated with a low confidence level that such input is an intentional fingertip interaction, e.g. an intentional fingertip hover or touch interaction.

Optionally, system and method for invalidating output obtained from a region classified as a region of unintended input is similar to methods described for example in International Patent Application No. PCT/IL2012/050048 filed on Feb. 15, 2012 assigned to N-Trig Ltd., the contents of which is incorporated herein by reference.

In some exemplary embodiments, the defined area over which palm input is expected is determined from output obtained when using a sensing configuration that is more sensitive to hovering. In some embodiments of the present invention, the defined area over which palm input is expected is defined based on output obtained from a self-capacitance detection method together with output obtained from when using a mutual capacitance detection method. In some exemplary embodiments, the defined area over which palm input is expected is determined based on changes in touch areas over a plurality of sampling cycles.

Optionally, during stylus interaction, a three dimensional orientation of the stylus is detected and used to determine the defined area over which palm input is expected.

Optionally, a direction of stylus movement is used to determine the defined area over which palm input is expected. Optionally, input received in the defined area over which palm input is expected in one or more sampling periods preceding and/or following a sampling period(s) is invalidated. Optionally, the methods described herein are used together with other known methods of palm detection to enhance an ability to differentiate between intentional and inadvertent input provided to a digitizer sensor.

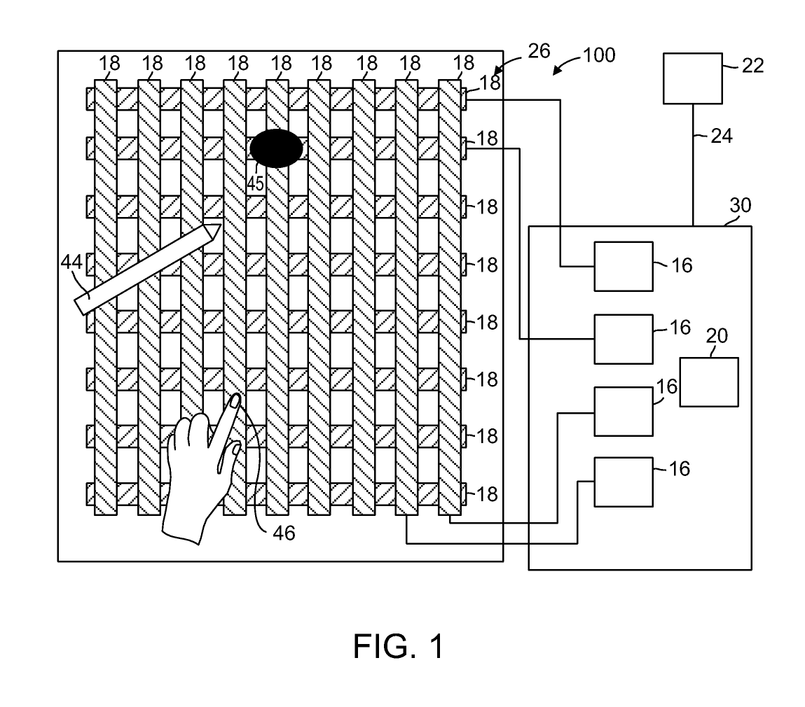

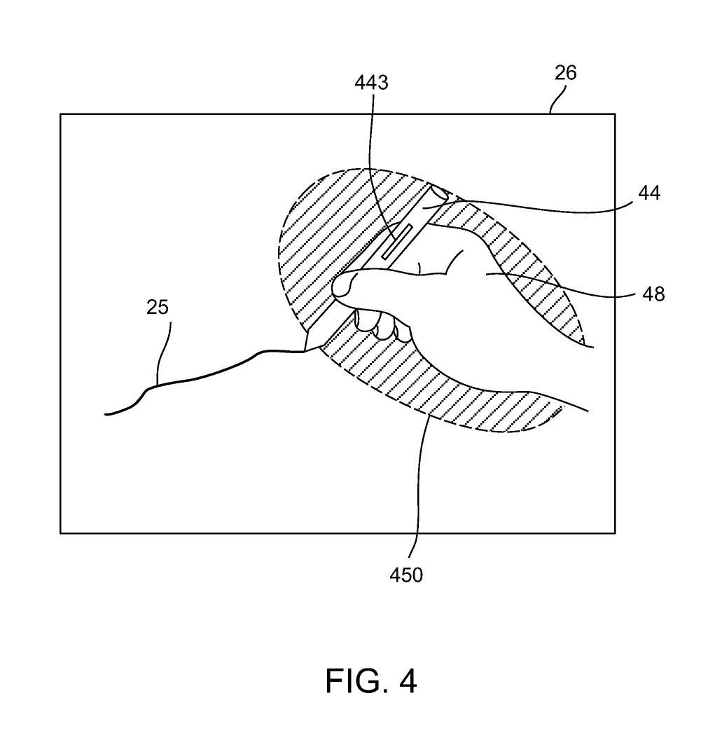

For purposes of better understanding some embodiments of the present invention, as illustrated in FIGS. 4-11 of the drawings, reference is first made to the construction and operation of an exemplary digitizer sensor and associated detection methods as shown in FIGS. 1-3. Reference is first made to FIG. 1 showing an exemplary simplified block diagram of a digitizer system that can be used in some embodiments of the present invention. The digitizer system 100 may be suitable for any computing device that enables touch and/or hover input between a user and the device, e.g. mobile and/or desktop and/or tabletop computing devices that include, for example, FPD screens. Examples of such devices include Tablet PCs, pen enabled lap-top computers, tabletop computers, PDAs or any hand held devices such as palm pilots and mobile phones or other devices that facilitate electronic gaming. According to some embodiments of the present invention, the digitizer system comprises a sensor 26 including a patterned arrangement of conductive lines 18, which is optionally transparent, and which is typically overlaid on a FPD. Typically sensor 26 is a grid based sensor including horizontal and vertical conductive lines forming a first and second axis.

According to some embodiments of the present invention, circuitry is provided on one or more PCB(s) 30 positioned around and/or in the vicinity of sensor 26. According to some embodiments of the present invention, one or more Application Specific Integrated Circuits (ASICs) 16 connected to outputs of the various conductive lines 18 in the grid is positioned on PCB(s) 30. Typically, ASICs 16 function to process the received signals at a first processing stage and to sample the sensor's output into a digital representation. The digital output signal is forwarded to a digital unit 20, e.g. digital ASIC unit also on PCB 30, for further digital processing. According to some embodiments of the present invention, digital unit 20 together with ASIC 16 serves as the controller of the digitizer system and/or has functionality of a controller and/or processor. Output from the digitizer sensor is forwarded to a host 22 via an interface 24 for processing by the operating system or any current application. Optionally, at least part of the processing is performed by host 22.

According to some embodiments, digital unit 20 produces and sends a triggering pulse to at least one of the conductive lines 18. Typically the triggering pulses and/or signals are analog pulses and/or oscillating signals. In some exemplary embodiments, finger touch detection is facilitated when sending a triggering pulse to the conductive lines. Typically, the presence of a finger and/or fingertip 46 decreases the triggering signal by 5-30% since finger 46 typically drains current from conductive lines 18 to ground. Detection of a token 45 is also facilitated when sending a triggering pulse to conductive lines 18 and typically increases amplitude of the triggering signal. In some exemplary embodiments, amplitude of the signal within a bandwidth of 18-40 KHz or 18-200 KHz is examined to detect fingertip and/or token touch. According to some embodiments of the present invention, a stylus 44 additionally interacts with digitizer sensor 26 by emitting a signal that can be picked up by one or more conductive lines 18. Triggering conductive lines 18 is typically not required for stylus detection. Typically a frequency of a signal emitted by stylus 44 is distinguishable from the triggering signal used for finger detection.

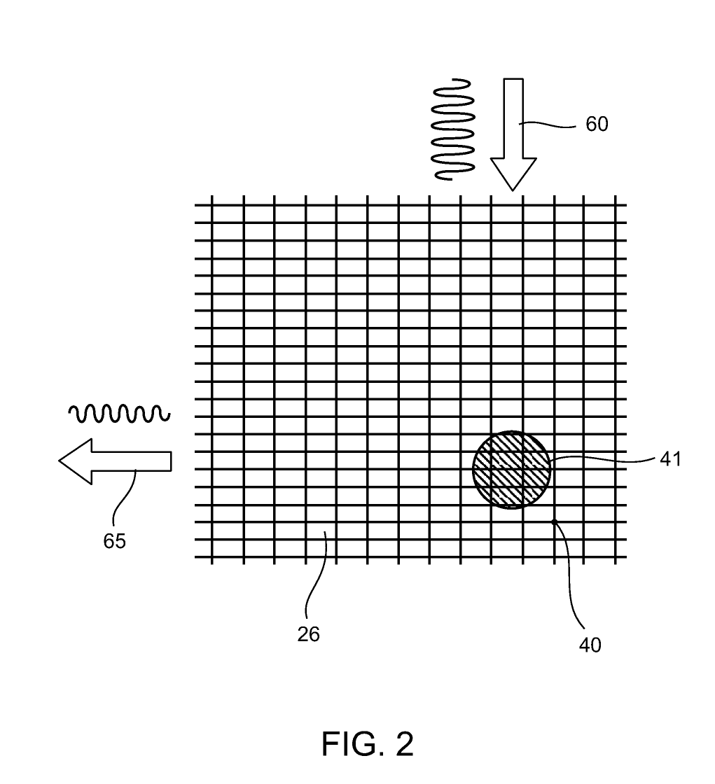

Reference is now additionally made to FIG. 2 showing a schematic illustration of an exemplary mutual capacitance detection method that can be used in some embodiments of the present invention. According to some embodiments of the present invention, a mutual capacitance touch detection method is used for identifying location of one or more fingertip touches 41 and/or capacitive objects (token) at the same time (multi-touch). During mutual capacitance detection digital unit 20 typically produces and sends AC signal 60 to each of conductive lines 18 along one axis in turn (the driving lines) and ASIC 16 in turn detects output from conductive lines 18 along the other axis (the passive lines). Output 65 is simultaneously sampled from each of the passive lines in response to each transmission of the triggering signal, e.g. interrogation signal to a driving line. Typically at each junction, e.g. junction 40 in digitizer sensor 26 a certain capacitance exists between orthogonal conductive lines so that a trigger pulse that includes an oscillating signal is transferred by virtue of capacitance to a conductive line with which a junction is formed. When finger 46 touches digitizer sensor 26 at or over an area 41 where triggering signal 60 is induced, the capacitance between the driving line and the passive lines proximal to the touch position changes and signal 60 crossing to the passive line produces a lower amplitude signal 65, e.g. lower in reference to base-line amplitude. Base-line amplitude is amplitude recorded while no user interaction is present. Optionally, a sensing configuration, e.g. amplitude threshold level for detection is defined to be lower than the base-line level by a pre-defined amount. Typically, the presence of a finger decreases the amplitude of the coupled signal by about 15-30% since the finger typically drains current from the lines to ground. Optionally, a finger hovering at a height of about 1-2 cm above the display can also be detected.

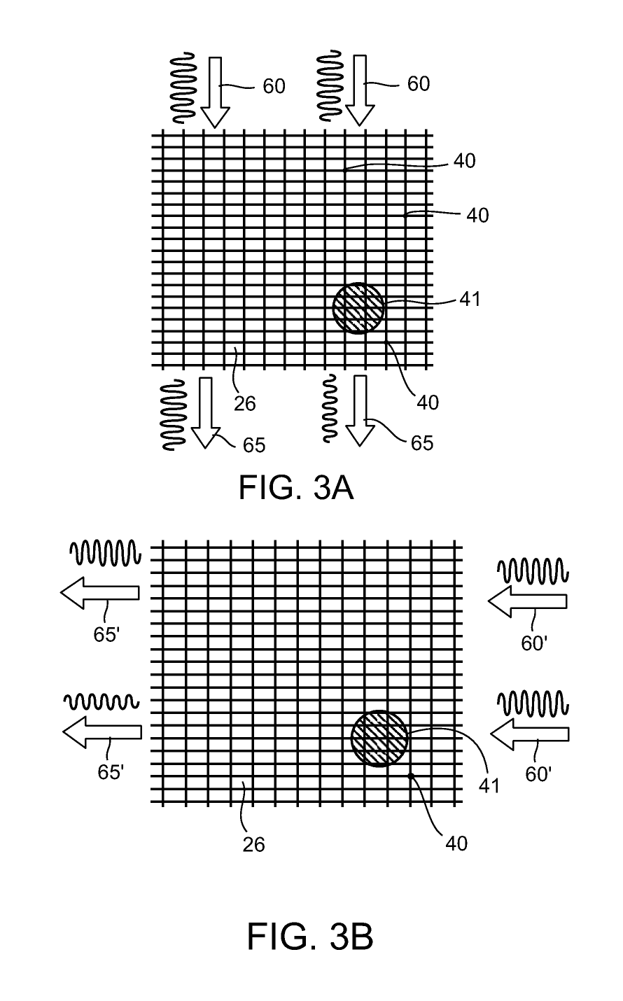

Reference is now additionally made to FIGS. 3A and 3B showing schematic illustrations of a self-capacitance detection method that can be used in some embodiments of the present invention. According to some embodiments of the present invention, a self-capacitance touch detection method is used for detecting interaction of one or more fingertips and/or tokens with digitizer sensor 26. Optionally, during self-capacitance touch detection, stylus input is also determined. During self-capacitance detection, digital unit 20 typically produces and simultaneously sends AC signal 60 to a plurality of conductive lines 18 and/or to all conductive lines 18 along one axis, and ASIC 16 detects output 65 from the same conductive lines 18 that are triggered (FIG. 3A). When finger 46 touches digitizer sensor 26 at a certain position 41 where triggering signal 60′ is induced, the capacitance formed between the finger and the conductive lines 18 in the vicinity of the finger produces a lower amplitude output signal 65, e.g. lower in reference to base-line amplitude. Based on output 65, conductive lines 18 along one axis of digitizer sensor 26 that are proximal to finger 46 are determined. Subsequently, digital unit 20 produces and simultaneously sends AC signal 60′ to each of conductive lines 18 along the other axis and ASIC 16 detects output 65′ from the same conductive lines 18 that are triggered (FIG. 3B). Based on output 65′, conductive lines 18 along the other axis of digitizer sensor 26 that are proximal to finger 46 are determined. Positions of touch are determined by combining information obtained from each of the axes.

Optionally, digital unit 20 simultaneously triggers all conductive lines 18 along both axes and ASICS 16 substantially simultaneously detect output 65 and 65′ from all conductive lines 18 along both axes. It is noted that although the triggering signal is shown to be introduced on one end of conductive lines 18 and the output is shown to be detected from an opposite end of conductive lines 18, this may not necessarily be the case. Optionally, triggering and detection is applied on a same end of conductive lines 18.

Typically, the self-capacitance detection method is advantageous in that it does not require scanning and therefore provides faster detection with fewer computations as compared to the mutual capacitance detection method. An additional advantage of self-capacitance detection is that it is typically more sensitive to hovering as compared to the mutual-capacitance detection. However, the self-capacitance detection method is limited in that locations of more than one fingertip interacting with the digitizer sensor cannot always be resolved due to ghosting. Ghosting occurs when more than one option for pairing output obtained from each axis is possible, and therefore touch location remain ambiguous. Systems and methods for using both self-capacitance detection and mutual capacitance detection are described in more detail for example in U.S. Patent Publication No. US20090251434 entitled “Multi Touch and Single Touch Detection,” assigned to N-Trig Ltd., the contents of which is incorporated herein by reference.

It should be noted that the embodiments of FIGS. 1-3 are presented as an exemplary “platform” for carrying out the invention. However in its broadest form, the invention is not limited to any particular platform and can be adapted to operate on any digitizer or touch or stylus sensitive display or screen that accepts and differentiates between two simultaneous user interactions. Digitizer systems used to detect stylus and/or finger touch location may be, for example, similar to digitizer systems described for example U.S. Pat. No. 6,690,156, U.S. Pat. No. 7,292,229 and/or U.S. Pat. No. 7,372,455 all assigned to N-Trig Ltd., the contents of all of which is incorporated herein by reference. The present invention may also be applicable to other digitizer sensor and touch screens known in the art, depending on their construction.

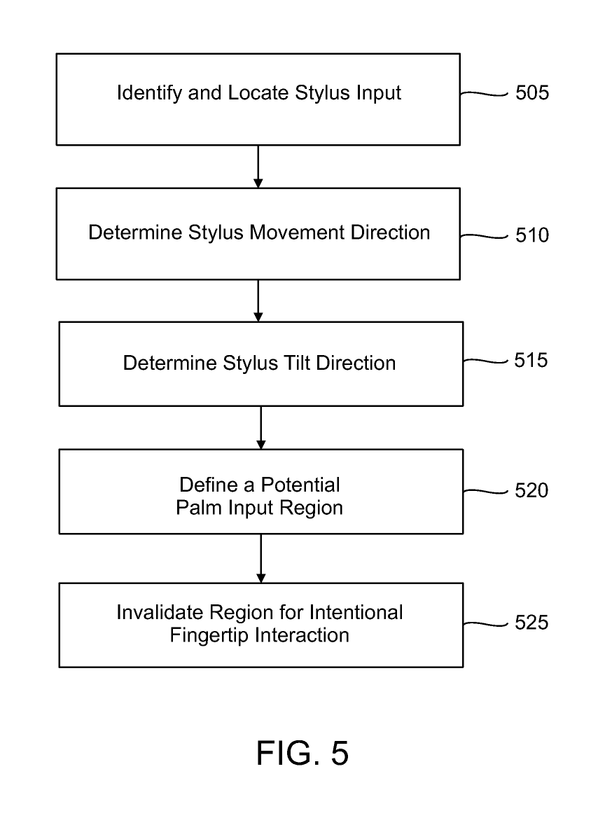

Reference is now made to FIG. 4 showing a schematic illustration of a potential palm input area that is defined based on position of a stylus interacting with a digitizer sensor and also to FIG. 5 showing a simplified flow chart of an exemplary method for identifying a potential palm input area during stylus interaction with a digitizer sensor, both in accordance with some embodiments of the present invention. At times while a user interacts with a digitizer sensor 26 using stylus 44, input from a hand 48 holding stylus 44 may be picked up by digitizer sensor 26. At times, input from hand 48 may be confused with intentional input provided by fingertip touch interacting with the digitizer together with stylus 44. The present inventors have found that information regarding location of stylus 44 and/or its three dimensional orientation can be used to define and/or predict an area 450 in digitizer sensor 46 covered by hand 48 holding the stylus. The present inventors have noted that intentional fingertip touch input is unlikely in area 450 covered by hand 48 holding a stylus and therefore any input received in that area may be assumed to be palm input and/or other inadvertent input.

According to some embodiments of the present invention, during interaction with a digitizer sensor 26, a stylus 44 is identified and its coordinates are detected (block 505). Interaction with digitizer sensor 26 may be by touch and/or hover. Typically, a potential location for palm input, e.g. area 450 covered by hand 48 is defined in relation to a current tip location of stylus 44 and the location is updated as the tip location changes. According to some embodiments of the present invention, a direction of movement of the stylus is also detected (block 510). As the tip locations moves, the defined location for potential palm input will be redefined and/or moved along in the direction that the tip moves. Optionally, a direction of tip movement is used to predict a potential location of palm input. For example, while a stylus moves from left to right to draw a line 25, it can be expected that hand 48 will be to the right of the movement. Alternatively, the opposite may be true for a particular user, e.g. a left-handed user and/or a particular language of interaction. Optionally, the determination is user-specific based on known parameters of the user.

Optionally in addition to location, orientation of the stylus is also determined and tracked (block 515). In some exemplary embodiments a tilt sensor 443 embedded in stylus 44 provides information regarding stylus tilt. Optionally, stylus 44 transmits a signal from more than one location along its length and three dimensional orientation of stylus 44 is determined from a plurality of inputs provided by stylus 44. Optionally stylus 44 may be similar to a stylus disclosed in International Patent Application No. WO2011154950, entitled “Orientation Detection with a Digitizer,” assigned to N-Trig Ltd., the contents of which is incorporated herein by reference.

According to some embodiments of the present invention, location of stylus 44 and one or more of stylus tilt and direction of stylus movement is used to define a potential palm input area (block 520). A size and/or orientation of the potential palm input area may be based on user-specific information and/or based on averages taken from a plurality of users. According to some embodiments of the present invention, any input obtained within the defined potential palm input area is invalidated as input provided from a fingertip touch (block 525). Typically, the defined potential palm input area is valid for a pre-defined period of time and/or until the defined potential palm input area is updated. Optionally, the defined potential palm input may be updated based on movement of associated fingertip touch, e.g. moved in relation to the fingertip touch 41. Optionally, updating of the defined potential palm input region may be additionally and/or alternatively performed with one or more methods described herein.

Optionally, input within region 450 is characterized and information regarding input in region 450 is provided to a host, e.g. provided in addition to coordinates of stylus 44. Optionally, palm input during stylus interaction is analyzed and used for signature verification and/or as additional input. Optionally, detection parameters, e.g. sensing configuration within region 450 are defined differently to increase the detection sensitivity for palm input, which typically includes both touch and hover areas. Optionally, input provided in region 450 is not automatically invalidated, but instead a confidence level attributed to the input is set lower than a same input provided in a region outside of region 450.

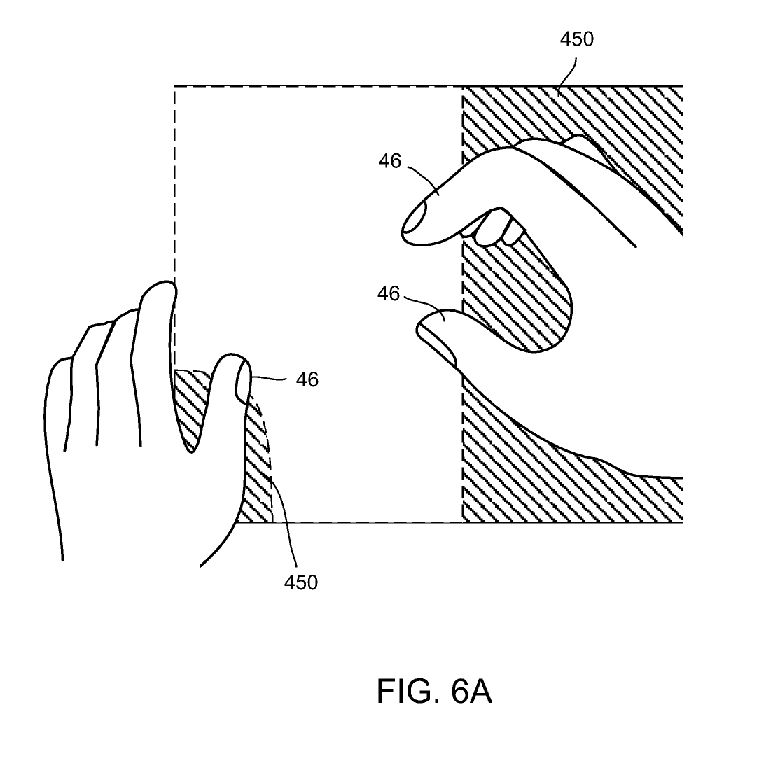

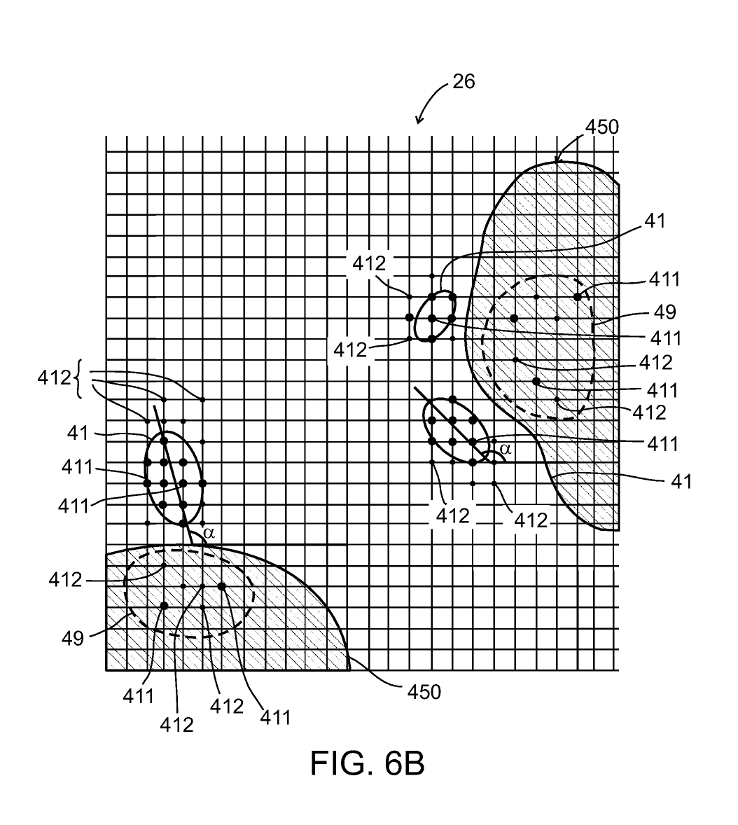

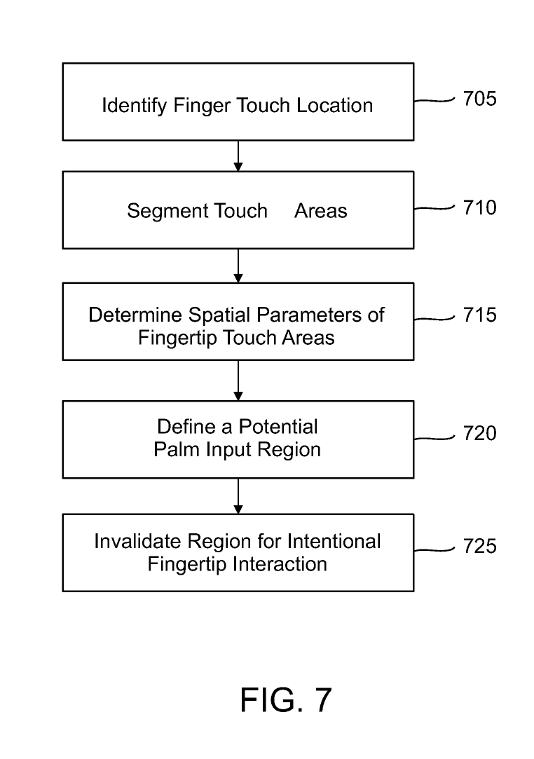

Reference is now made to FIGS. 6A and 6B showing exemplary schematic illustrations of hands interacting with a digitizer sensor and corresponding output detected on the digitizer sensor based on which potential palm input areas are defined, and to FIG. 7 showing a simplified flow chart of an exemplary method for identifying a potential palm input area based on hand mapping during finger touch interaction with a digitizer sensor in accordance with some embodiments of the present invention. According to some embodiments of the present invention, position and/or orientation of one or more fingers 46 touching digitizer sensor 26 are examined based on one or more fingertip touch areas 41 detected on digitizer sensor 26 (FIG. 6B). According to some embodiments of the present invention, during operation, touch points on the digitizer are identified (block 705) and segmented into touch regions (block 710). Optionally, the touch regions are classified as fingertip input region 41 and palm input region 49, based on size, shape and/or amplitude output of the regions. Optionally, segmentation is performed using more than one threshold level for detection and/or sensing configuration so that larger palm input areas 49 that include both touch and hover areas of a palm can be combined into larger groups. For example, one set of touch input points 411 (shown as large dots) may be obtained using one sensing configuration for detection, while additional touch points 412 (shown as small dots) may be obtained when adjusting the sensing configuration, e.g. increasing the threshold level for detection for finger touch detection. Optionally, segmentation is performed with methods described in incorporated U.S. Application Publication No. 2011-0310040.

According to some embodiments of the present invention, spatial parameters of the touch areas 41 classified as fingertip touch, e.g. size, shape and/or angle are determined (block 715). Typically input provided by one or more finger touches has an oblong shape, e.g. an ellipse while palm input may have a banana curved shaped and/or an irregular shape.

Optionally, an angle a that a major axis of the oblong shape makes with an axis of the digitizer is detected. Size of each touch area and relative positioning between the touch areas may also be detected and used to map out the orientation of the hand providing the fingertip touches. Optionally, the touch areas are segmented into different hands based on the analysis and more than one potential palm area is defined. According to some embodiments of the present invention, potential palm areas are defined based on analysis of hand position and/or detection of palm input areas (block 720). Typically, input provided in a potential palm input region is invalidated as an intentional fingertip interaction for a pre-defined period of time and/or until an updated potential palm input region (725). Input provided in the defined potential palm input region can be ignored, e.g. not reported to the host, or can be reported to the host and labeled as input other than intentional fingertip touch input. Optionally, the defined potential palm input may be updated based on movement of associated fingertip touch, e.g. moved together with the fingertip touch 41. Optionally, updating of the defined potential palm input region may be additionally and/or alternatively performed with one or more methods described herein. Typically although not necessarily, the potential palm input area that is defined is larger than an identified region of palm input. Optionally, the potential palm input area has a predefined size. Optionally the size of the palm input area is determined based on a detected orientation of the hand and/or based on pre-defined parameters for a particular user that is defined in a calibration procedure.

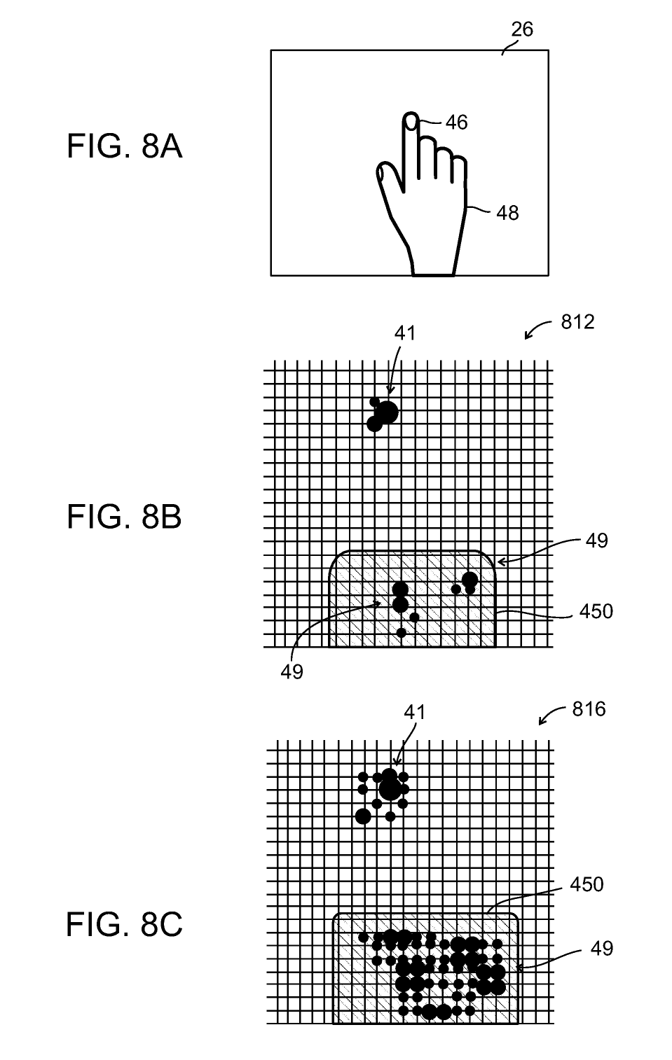

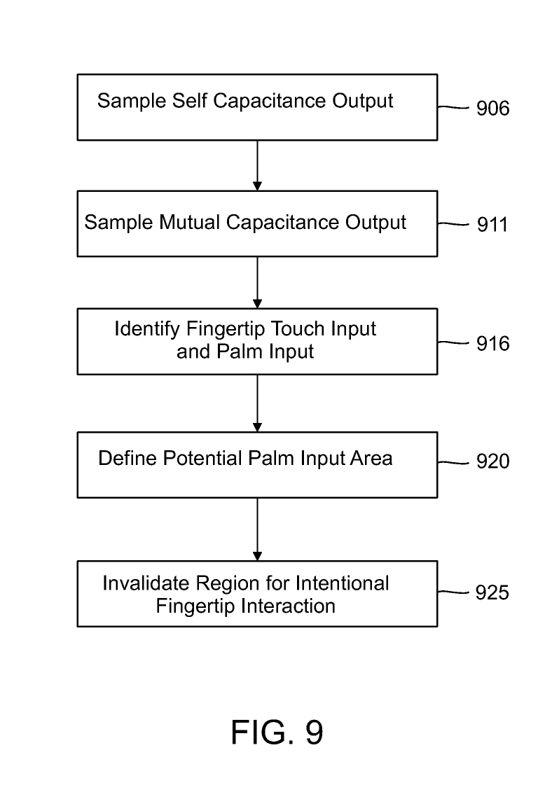

Reference is now made to FIGS. 8A, 8B and 8C showing schematic illustrations of a finger interacting with a digitizer sensor and corresponding output obtained during mutual capacitance detection and self capacitance detection respectively, and to FIG. 9 showing a simplified flow chart of an exemplary method for identifying a potential palm input region using output obtained from self-capacitance detection method, all in accordance with some embodiments of the present invention. According to some embodiments of the present invention, a digitizer system providing multi-touch detection uses both a self capacitance detection method and a mutual capacitance detection method for identifying interaction by a finger 46 and/or other capacitive object with a digitizer sensor. Typically, output based on mutual capacitance detection 812 (FIG. 8B) can distinguish between multiple touches occurring at the same time, e.g. without ghosting, but is typically less sensitive to hovering.

On the other hand, while output based on self capacitance detection 816 (FIG. 8C) may suffer from ghosting effects, it is typically more sensitive to hover. It is noted that in FIGS. 8B and 8C, different amplitude of output is schematically represented as different sized dots with the larger dots representing a higher detection level. The present inventors have found that the increased sensitivity to hover obtained using self capacitance detection can be used to help identify a general area of palm input. Since the palm is typically not flat, additional information regarding hovering portions of the palm may help identify an expanded area affected by palm input 49 obtained from a palm 48. According to some embodiments of the present invention, during operation of a digitizer sensor, both self capacitance output is sampled (block 906) and mutual capacitance output is sampled (block 911). According to some embodiments of the present invention, outputs obtained from both detection methods are compared and used to identify fingertip touch input area 41 and palm input area 49 (block 916). Optionally, a potential palm input area 450 is identified based on identified palm input (block 920). Typically although not necessarily, the potential palm input area that is defined is larger than an identified region of palm input. Optionally, the potential palm input area has a predefined size. Optionally the size of the palm input area is determined based on a detected orientation of the hand and/or based on pre-defined parameters for a particular user that is defined in a calibration procedure. Typically, input provided in a potential palm input region is invalidated as an intentional fingertip interaction for a pre-defined period of time and/or until an updated potential palm input region is determined (block 925). Input provided in the defined potential palm input region can be ignored, e.g. not reported to the host or can be reported to the host and labeled as input other than intentional fingertip touch input.

Optionally, the defined potential palm input may be updated based on movement of associated fingertip touch, e.g. moved in relation to the fingertip touch 41. Optionally, updating of the defined potential palm input region may be additionally and/or alternatively performed with one or more methods described herein.

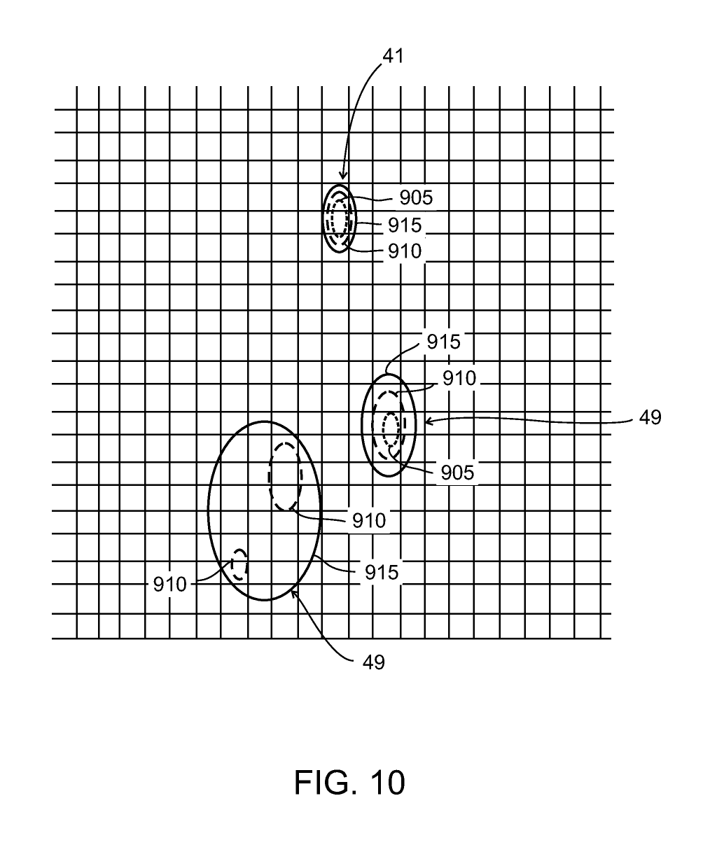

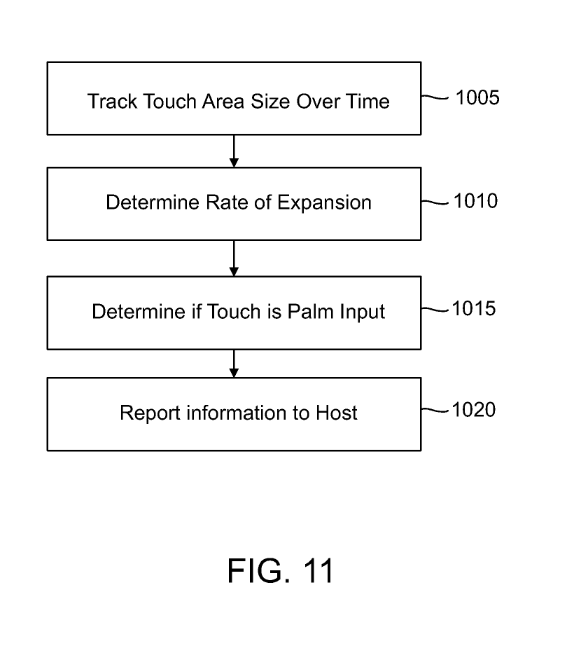

Reference is now made to FIG. 10 showing schematic illustration of a fingertip touch area and a palm touch area as detected over three consecutive sampling periods and FIG. 11 showing a simplified flow chart of an exemplary method for identifying palm input based on changes in a touch area over a plurality of sampling periods, all in accordance with some embodiments of the present invention. The present inventors have found that at the onset of a touch event, palm touch may cover a small area such as is typically covered by a fingertip touch interaction, and therefore may be confused with a fingertip touch input. However, as the touch area expands over subsequent sampling periods, differences in touch area typically develop. The present inventors have found that the rate of expansion of palm touch area 49 is typically greater than that of fingertip touch area 41 and by examining the rate of expansion, palm input can be distinguished from touch input. The present inventors have found that palm input can be detected at an earlier stage based on rate of expansion as compared to size of input area. According to some embodiments of the present invention, size of a touch area is tracked over a plurality of consecutive samples 905, 910 and 915 (block 1005). It is noted that although output over three samples is shown for exemplary purposes, any number of samples may be used to determine a rate of expansion of a touch area, e.g. output over two sampling periods and/or over 3-10 sampling periods or more, may be used. Optionally, expansion is tracked over every other sampling period or every third to fifth sampling period. Typically at the onset of touch, a size of a touch is smallest at the earliest sampling period 905 and the size of the touch increases over a plurality of sampling periods as a finger and/or hand is pressed further toward the digitizer sensor. According to some embodiments of the present invention, a rate of increase in size is tracked and used as an indicator to classify a touch area as a fingertip touch area 41 or a palm input area 49 (block 1010). Optionally, a rate of change typical of palm input is pre-defined based on a calibration procedure or parameters defined in a manufacturing site, e.g. based on experimental data. Optionally, joining of one or more touch areas may be tracked over a plurality of sampling periods and used to identify palm input. According to some embodiments of the present invention, palm input is defined for a rate of change above a pre-defined level (block 1015). According to some embodiments of the present invention, a detected palm input is reported to a host (1020). Optionally, the digitizer system maintains a list of previous reports to determine if classification of touch area has changed due to detected features of the touch area over time. In some exemplary embodiments when a change in classification is determined, instructions to re-classify a specific past touch event are provided to the host. Optionally, a potential palm input region in the vicinity of the identified palm input region is defined. Optionally, the methods described herein in reference to FIGS. 10 and 11 is used to differentiate between intentional input and inadvertent input, and a rate of change typical of a specific unintentional input other than a palm, e.g. an ear or cheek is pre-defined based on a calibration procedure or parameters defined in a manufacturing site, e.g. based on experimental data.

According to some embodiments of the present invention, a potential palm input area once defined using one or more methods described herein, is used to invalidate input detected and within the potential palm input over one or more previous and/or subsequent sampling periods. Optionally, input detected within the potential palm input area is automatically invalidated as a possible intentional fingertip interaction without further analysis of that input. Optionally, the potential palm input area is adjusted to move along with a stylus and/or fingertip touch area, as long as the stylus and/or fingertip touch is maintained on the digitizer. It is noted that although the potential palm input area is used to invalidate an intentional fingertip touch interaction, input in the potential palm input area may still be used and/or reported to a host, e.g. as palm input. Optionally, input from the potential palm input area can be used to provide additional information to the host that can be used for example for signature verification and/or to enhance functionality of the digitizer. Optionally, input provided in potential palm input area is not automatically invalidated, but instead a confidence level attributed to the input is much lower than a same input provided in a region outside of potential palm input region.

It is noted that although the blocks in the flow charts shown in FIGS. 5, 7 and 9 appear one after the other, it is clear to a person that is skilled in the art that at least some of the blocks in FIGS. 5, 7 and 9 may be executed in parallel.

Typically, the presence of a finger and/or fingertip 46 decreases the measured signal by 5-30% relatively to a measurement in the absence of touch, since finger 46 typically drains current from conductive lines 18 to ground. The present inventors have found that the degree by which the signal is decreased due to the presence of finger 46 depends on the sensor's impedance to ground. The present inventors have found that a digitizer sensor that has low impedance to ground, e.g. directly connected to ground is typically more sensitive to capacitive touch than a digitizer sensor that has higher or high impedance to ground since the touched areas may be more distinct. The present inventors have also found a digitizer sensor's sensitivity to touch can change during an operation session in response to changes in its impedance to ground. For example a mobile device including a digitizer sensor may provide higher sensitivity to touch while positioned on a large metal table and lower sensitivity to touch while positioned on a glass table. In another example, sensitivity to touch may be increased in response to a user holding the mobile device.

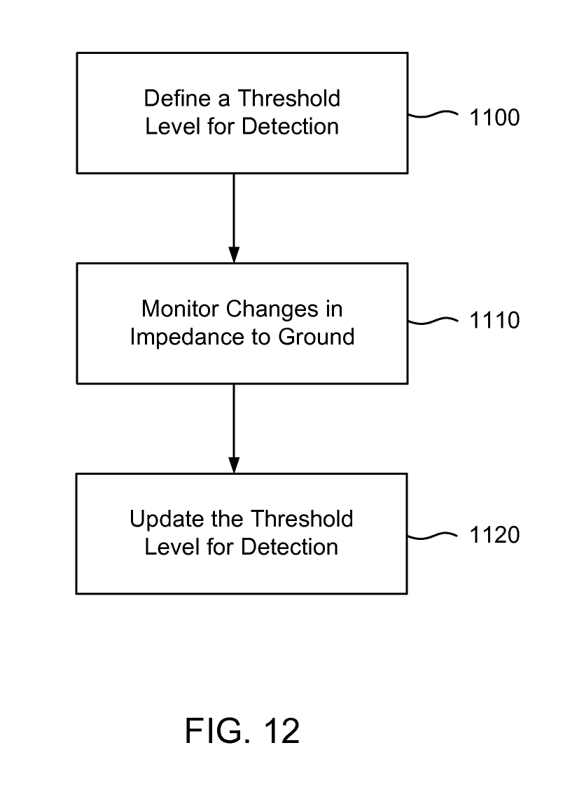

Reference is now made to FIG. 12 showing a simplified flow chart of an exemplary method for adjusting a threshold level for detection based on variations in a system's impedance to ground. In some exemplary embodiments, the threshold level for detection is defined based on predicted and/or known impedance to ground (block 1100). In some exemplary embodiments, for digitizer systems integrated with a stationary computing device, e.g. a personal computer, a high threshold level is defined since the device is expected to have low impedance to ground and therefore a signal in response to finger touch is expected to be relatively high and/or strong. In some exemplary embodiments, for digitizer systems that are part of a mobile computing device, e.g. a mobile telephone, a lower threshold level is defined since the device is expected to have higher impedance to ground and therefore a signal in response to finger touch is expected to be lower. In some exemplary embodiments, the threshold for detecting touch is not applied directly on the output detected by the digitizer but rather on ratios between voltage level measured in association with each junction of a digitizer sensor when the junction is touched and a voltage level measured in association with each corresponding junction when the junction is untouched, e.g. in the absence of touch. Methods for defining the ratio is described in detailed for example in incorporated U.S. Application Publication No. 2011-0310040.

Optionally, the impedance level to ground and/or changes in the impedance to ground is monitored and/or detected over a course of operation with the digitizer sensor (block 1110) and the threshold level for detection is updated based on the detected impedance level and/or the detected changes (block 1120).

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

What is claimed is:

1. A method for classifying input provided to a digitizer sensor, the method comprising:
sampling output over one or more sampling periods;
identifying a location of intentional input to the digitizer sensor from the output sampled over the one or more sampling periods;
identifying an area of potential palm input based on the identified location of the intentional input, wherein the area of potential palm input is defined to have a defined spatial relation to the location of the intentional input; and
classifying output detected in the area of the potential palm input as output potentially obtained from undesired input to the digitizer sensor, wherein the output classified is sampled over one or more sampling periods other than the one or more sampling periods from which the area of potential palm input is identified.

2. The method of claim 1, wherein the area of potential palm input is updated over subsequent sampling periods responsive to changes in the location of the intentional input.

3. The method of claim 1, wherein the area of potential palm input is defined as a dynamic area that is updated as the location of the intentional input is updated.

4. The method of claim 1, wherein the intentional input to the digitizer sensor is input provided by a stylus.

5. The method of claim 4, comprising determining an orientation of the stylus and identifying the area of potential palm input in relation to the orientation of the stylus.

6. The method of claim 5, wherein determining an orientation of the stylus includes determining a three dimensional orientation of the stylus with respect to the digitizer sensor as identified.

7. The method of claim 4, wherein the area of potential palm input in relation to the orientation of the stylus is defined as an area on the digitizer sensor covered by the stylus and a hand holding the stylus.

8. The method of claim 4, comprising determining a moving direction of the intentional input and defining the area of potential palm input in relation to the moving direction.

9. The method of claim 1, wherein the intentional input is input provided by one or more fingertip touches.

10. The method of claim 9, comprising:
determining an angle of at least one fingertip touch with respect to an axis of the digitizer sensor; and
defining the area of potential palm input in relation to the angle of at least one fingertip touch.

11. The method of claim 9, comprising:
identifying one or more features of the at least one fingertip touch;
identifying a hand structure from the one or more features; and
determining the area of potential palm input responsive to the identified hand structure.

12. The method of claim 9, comprising:
determining the output using more than sensing configuration;
identifying an interaction area on the digitizer sensor that is larger than a threshold size area for identifying palm input; and
defining the area of potential palm input in the vicinity of the interaction area that is larger than a threshold area for identifying palm input.

13. The method of claim 9, comprising sampling output using a self-capacitance detection method and a mutual capacitance detection method, and determining the area of potential palm input responsive to output obtained from both the self-capacitance detection method and the mutual capacitance detection method.

14. The method of claim 9, comprising determining a size of an area over which the intentional input is provided over a plurality of sampling periods, and invalidating the input as intentional input responsive to the rate in the change of size being larger than a pre-defined rate.

15. The method of claim 1, wherein input detected within the area of potential palm input is refrained from being reported to the host.

16. The method of claim 1, wherein input detected within the area of potential palm input is reported to the host as undesired input.

17. The method of claim 1, wherein input detected within the area of potential palm input is associated with a reduced level of confidence that the input is an intentional input provided by fingertip touch.

18. The method of claim 1, wherein the intentional input to the digitizer sensor is one of touch input and hover input.

19. The method of claim 1, wherein a size of the area of potential palm input is a pre-defined.

20. The method of claim 19, wherein the pre-defined size is user specific.

21. A method for classifying input provided to a digitizer sensor, the method comprising:
sampling output over at least two sampling periods;
determining an area of input based on the sampled output;
determining a change in size of the area of input over the at least two sampling periods; and
invalidating the input as intentional input responsive to the change of size being larger than a pre-defined threshold.

22. A method for detecting finger touch to a digitizer sensor, the method comprising:
defining a threshold level of output for identifying a presence of a finger over the digitizer sensor;
determining a change in the digitizer sensor's impedance to ground; and
adjusting the threshold level response to the change in the digitizer sensor's impedance to ground.

23. The method of claim 22 comprising:
defining ratios between voltage level measured in association with each junction of the digitizer sensor when the junction is touched and a voltage level measured in association with each corresponding junction when the junction is untouched is used to detect touch; and
applying the threshold on the ratios to detect the presence of the finger over the digitizer sensor.
